(19) United States
(12) Patent Application Publication
(10) Pub. No.: US 2014/0072697 A1
(43) Pub. Date: Mar. 13, 2014

(54) METHOD FOR MANUFACTURING ELECTRODE FOR BATTERY

(71) Applicant: DAINIPPON SCREEN MFG. CO., LTD., Kyoto (JP)

(72) Inventor: Kenta HIRAMATSU, Kyoto-shi (JP)

(21) Appl. No.: 13/932,114

(22) Filed: Jul. 1, 2013

(30) Foreign Application Priority Data
Sep. 13, 2012 (JP) JP2012-201401

(51) Int. Cl. H01M 4/04

(52) U.S. Cl. CPC H01M 4/0404
USPC 427/58

(57) ABSTRACT

A method for manufacturing an electrode for a battery includes: a mixing step of dry-mixing an active material and a conductive aid; a pressing step of applying a pressure for pressing to the mixture obtained in the mixing step; a step of mixing a solvent into the mixture after the pressing step to prepare a slurry (in paste form) active material; and an application step of applying the slurry active material onto a current collector to form an active material layer.

### BACKGROUND OF THE INVENTION

1. Field of the Invention

The present invention relates to a method for manufacturing an electrode for a battery such as a lithium ion secondary battery that has a solid electrolyte layer interposed between active material layers.

2. Description of the Background Art

Lithium ion secondary batteries (Lithium ion rechargeable batteries) each composed of a positive electrode, a negative electrode, an electrolyte (solid electrolyte), a separator, etc. are light in weight, high in capacity, and able to be charged and discharged at high rates, and thus have been now widely used in the field of mobile devices such as lap-top computers and cellular phones, the field of automobiles, etc. In order to further increase the capacities of lithium ion secondary batteries, and charge and discharge the batteries at higher rates, various studies have been carried out.

For example, the capacity of a lithium ion secondary battery and the charge/discharge speed thereof are limited by reactions of an electrolyte with a positive electrode active material and a negative electrode active material respectively contained in a positive electrode and a negative electrode. Owing to the relatively low lithium ion conductivity of the electrolyte, in order to increase the capacity and achieve charge and discharge at high rates, it is important to make the gap between the positive electrode and the negative electrode narrow as much as possible and make the electrode areas of the positive electrode and negative electrode large as much as possible, in particular, increase the contact area between the positive electrode active material and the electrolyte and the contact area between the negative electrode active material and the electrolyte.

In this regard, for example, Japanese Patent Application Laid-Open No. 2011-198596 proposes a technique intended to provide a solid electrolyte secondary battery structure that achieves low cost, high safety, high energy density, and high output power.

More specifically, Japanese Patent Application Laid-Open No. 2011-198596 discloses “a method for manufacturing an all-solid battery, characterized in that it includes: a first active material layer forming step of applying an application liquid containing a first active material onto a surface of a base material to form a continuous first active material layer; . . . an electrolyte layer forming step of applying an application liquid containing a polyelectrolyte onto a surface of a stacked body including the first active material layer, . . . stacked on the surface of the base material to form an electrolyte layer having asperity substantially following asperity of the stacked body surface; . . . ”, and discloses an active material layer that has a so-called line-and-space structure including a linear active material pattern.

On the other hand, in the case of obtaining a commonly used electrode for a secondary battery in which an active material layer has a membrane-like flat structure, the electrode is prepared in such a way that a paste active material is applied onto a current collector such as aluminum foil or copper foil, dried, and then subjected to press working so that the obtained membrane-like active material layer has a predetermined density. This press working is aimed at densifying the active material layer, and improving electron conductivity in the finally obtained electrode and the adhesion between the active material layer and the current collector.

However, in the case of the active material layer including the linear active material pattern obtained in Japanese Patent Application Laid-Open No. 2011-198596, the active material pattern has a substantially linear shape, a small ground contact area with the base material, and a high aspect ratio, and thus may fall down or collapse when the layer is subjected to press working as described above. For this reason, press working is forced to be skipped, and as a result, there is a problem of failing to obtain any dense active material layer.

### SUMMARY OF THE INVENTION

The present invention is directed to a method for manufacturing an electrode for a battery. According to the present invention, the method for manufacturing an electrode for a battery includes the following steps: a) dry-mixing an active material and a conductive aid; b) applying a pressure for pressing to the mixture obtained in the step a); c) mixing a solvent into the mixture after the step b) to prepare a slurry (in paste form) active material; and d) applying the slurry active material onto a current collector to form an active material layer.

According to the method for manufacturing an electrode for a battery according to this aspect, the powder mixture including the active material which is generally bulky and conductive aid and the active material obtained by using the mixture have tap densities improved. Therefore, an electrode formed with the use of the active material is small in porosity and high in density. Thus, in the obtained electrode, the contact resistance is decreased between active material particles and conductive aid particles to improve battery characteristics. In addition, the solvent usage in the preparation of the slurry active material can be reduced. Furthermore, it is possible to skip press working for the active material layer to increase the throughput.

In the method for manufacturing an electrode for a battery according to another aspect of the present invention, a pressure of 5 MPa or more and 300 MPa or less (5 to 300 MPa) is preferably applied to the mixture for pressing in the step (b).

The pressure of 5 MPa or more decreases the volumes of the powder mixture and active material obtained by using this mixture, and has advantages such as a decrease in the viscosity of the obtained slurry active material and an improvement in the filling ratio of the finally obtained electrode. In addition, the pressure of 300 MPa or less will not destroy the active material.

According to the present invention, a method for manufacturing a battery electrode including an active material layer can be provided, which can form a dense active material layer without applying any press working to the active material layer or active material pattern.

Therefore, an object of the present invention is to provide a method for manufacturing a battery electrode including an active material layer, which can form a dense active material layer without applying any press working to the active material layer or active material pattern.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic longitudinal sectional view of a lithium ion secondary battery manufactured according to a preferred embodiment of the present invention;

FIG. 2 is a schematic perspective view of a structure (negative electrode) that has a negative electrode active material layer pattern formed from a negative electrode active material layer on the surface of a negative electrode current collector according to a preferred embodiment of the present invention;

FIG. 3 is a diagram illustrating the configuration of a negative electrode manufacturing apparatus according to a preferred embodiment of the present invention;

FIGS. 4A and 4B are diagrams each schematically illustrating the formation of a negative electrode active material layer pattern formed from a negative electrode active material layer by a nozzle dispensing method according to a preferred embodiment of the present invention;

FIG. 5 is a diagram schematically illustrating the formation of a solid electrolyte layer by use of a spin coat method according to a preferred embodiment of the present invention;

FIGS. 6A and 6B are diagrams each schematically illustrating the formation of a positive electrode active material layer by use of a doctor blade method; and

FIG. 7 is a schematic longitudinal sectional view of a modification example of a lithium ion secondary battery according to the present invention.

### DESCRIPTION OF THE PREFERRED EMBODIMENTS

While a preferred embodiment of a method for manufacturing an electrode for a battery according to the present invention will be described below with reference to the drawings, the present invention is not to be considered limited to only this preferred embodiment. It is to be noted that in the following description, the same or corresponding parts may be denoted by the same reference numerals to omit overlapping explanations. In addition, the drawings are intended to conceptually describe the present invention, and may be thus provided with dimensions, ratios, or numbers exaggerated or simplified in some cases, if necessary, for facilitating understanding of the present invention.

(1) Structure of Lithium Ion Secondary Battery

In the present preferred embodiment, the present invention will be described with reference to a case of manufacturing a lithium ion secondary battery that has the structure shown in FIG. 1, as an example of the present invention. FIG. 1 is a schematic longitudinal sectional view of a lithium ion secondary battery 1 manufactured according to the present preferred embodiment. In addition, FIG. 2 is a perspective view illustrating a structure 20 (more specifically, a negative electrode including a negative electrode current collector 10 and negative electrode active material layers 12 formed on the surface of the negative electrode current collector 10) obtained when the negative electrode active material layers 12 are formed on the surface of the negative electrode current collector 10.

The lithium ion secondary battery 1 according to the present preferred embodiment has a structure of the negative electrode active material layer 12, a solid electrolyte layer 14, and a positive electrode active material layer 16, and a positive electrode current collector 18 stacked in this order on the negative electrode current collector 10. The negative electrode current collector 10 and the negative electrode active material layer 12 constitute a negative electrode, whereas the positive electrode active material layer 16 and the positive electrode current collector 18 constitute a positive electrode. In this specification, X-, Y-, and Z-axis directions are defined as shown in FIGS. 1, 2, etc.

While materials known in the technical field of the present invention can be used as the negative electrode current collector 10, the negative electrode current collector 10 may be a metal film such as, for example, aluminum foil and copper foil. In addition, although not shown in the figure, this negative electrode current collector 10 may be formed on the surface of an insulating base material. A plate-like member formed from an insulating material may be used as the base material, and examples of the insulating material include, for example, resins, glass, and ceramics. In addition, the base material may be a flexible substrate with flexibility.

Materials commonly used in the technical field of the present invention can be used as the negative electrode active material contained in the negative electrode active material layer 12, and include, for example, metals, metal fibers, carbon materials, oxides, nitrides, silicon, silicon compounds, tin, tin compounds, various types of alloy materials. Among these materials, oxides, carbon materials, silicon, silicon compounds, tin, tin compounds, and the like are preferred in consideration of magnitude of capacity density, etc. The oxides include, for example, lithium titanate represented by the formula: Li_{4/3}Ti_{5/3-X}FeₓO₄ (0≦x≦0.2). The carbon materials include, for example, various types of natural graphite, coke, partially graphitized carbon, carbon fibers, spherical carbon, various types of artificial graphite, and amorphous carbon. The silicon compounds include, for example, silicon-containing alloys, silicon-containing inorganic compounds, silicon-containing organic compounds, and solid solutions. Specific examples of the silicon compounds include, for example, silicon oxides represented by SiOₐ (0.05<a<1.95); alloys containing silicon and at least one element selected from Fe, Co, Sb, Bi, Pb, Ni, Cu, Zn, Ge, In, Sn, and Ti; silicon compounds or silicon containing alloys in which some of silicon, silicon oxide, or silicon contained in alloys is substituted with at least one element selected from B, Mg, Ni, Ti, Mo, Co, Ca, Cr, Cu, Fe, Mn, Nb, Ta, V, W, Zn, C, N, and Sn; and solid solutions thereof. The tin compounds include, for example, SnO_{b} (0<b<2), SnO₂, SnSiO₃, Ni₂Sn₄, and Mg₂Sn. One of the negative electrode active materials may be used singly, or two or more thereof may be used in combination, if necessary.

In addition, the negative electrode active material layer 12 may contain a conductive aid. As the conductive aid, ones commonly used in the technical field of the present invention can be used, and examples of the conductive aid include, for example, graphite such as natural graphite and artificial graphite; carbon black such as acetylene black, Ketjen Black, channel black, furnace black, lampblack, and thermal black; conductive fibers such as carbon fibers and metal fibers; carbon fluoride; metal powders such as aluminum; conductive whiskers such as zinc oxide; conductive metal oxides such as titanium oxide; and organic conductive materials such as phenylene derivatives. One of the conductive aids may be used singly, or two or more thereof may be used in combination, if necessary.

As shown in FIG. 1, the thin-film solid electrolyte layer 14 with a substantially uniform thickness, which is formed from a solid electrolyte, is provided on top of the negative electrode active material layer 12. The solid electrolyte layer 14 uniformly covers substantially the entire upper surface of a negative electrode 20 so as to follow surface asperity of the negative electrode 20 formed of the negative electrode current collector 10 and the negative electrode active material layer 12, and the surface of the solid electrolyte layer 14 also has asperity.

Examples of the solid electrolyte contained in the solid electrolyte layer 14 include polyelectrolyte materials such as resins such as, for example, polyethylene oxide and/or polystyrene, and examples of the support salt include, for example, lithium hexafluorophosphate (LiPF₆), lithium perchlorate (LiClO₄), and lithium bistrifluoromethane sulfonylimide (LiTFSI). Boric acid ester polymer electrolytes may be used. As a matter of course, various types of additives may be mixed to the extent that the advantageous effect of the present invention is not undermined.

The positive electrode active material layer 16 is provided on top of the solid electrolyte layer 14 as shown in FIG. 1. The lower surface of the positive electrode active material layer 16 has asperity to follow the upper surface asperity of the solid electrolyte layer 14, whereas the upper surface thereof has a substantially flat shape. Likewise, this positive electrode active material layer 16 also has a high aspect ratio and height, because the negative electrode active material layer 12 has a high aspect ratio and height as described above.

Examples of the positive electrode active material (powder) contained in the positive electrode active material layer 16 include, for example, lithium-containing composite metal oxides, chalcogen compounds, and manganese dioxide. The lithium-containing composite metal oxides refer to metal oxides containing lithium and a transition metal, or to metal oxides in which some of the transition metal is substituted with a different type of element. Examples of the different type of element herein include, for example, Na, Mg, Sc, Y, Mn, Fe, Co, Ni, Cu, Zn, Al, Cr, Pb, Sb, and B, and among these elements, Mn, Al, Co, Ni, Mg, and the like are preferred. The different type of element may be one of these elements, or two or more thereof. Among these materials, the lithium-containing composite metal oxides can be preferably used. The lithium-containing composite metal oxides include, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, Li₂MPO₄F (in the respective formulas, for example, M is at least one selected from the group consisting of Na, Mg, Sc, Y, Mn, Fe, Co, Ni, Cu, Zn, Al, Cr, Pb, Sb, V, and B; 0<x≦1.2; 0<y≦0.9; and 2.0≦z≦2.3), and LiMeO₂ (in the formula, Me=MxMyMz; Me and M are transition metals; and x+y+z=1). Specific examples of the lithium-containing composite metal oxides include, for example, LiNi_{1/3}Mn_{1/3}Co_{1/3}O₂ and LiNi_{0.8}Co_{0.15}Al_{0.05}O₂. The x value herein indicating the molar ratio of lithium in the respective formulas mentioned above is increased and decreased by discharge and charge. In addition, the chalcogen compounds include, for example, titanium disulfide and molybdenum disulfide. One of the positive electrode active materials may be used singly, or two or more thereof may be used in combination. The positive electrode active material layer 16 may contain therein the conductive aid as listed for the negative electrode active material layer 12.

The positive electrode current collector 18 is stacked on the upper surface of the positive electrode active material layer 16 which has a substantially flat shape, thereby forming the lithium ion secondary battery 1. While materials known in the technical field of the present invention can be used as the positive electrode current collector 18, the positive electrode current collector 18 may be a metal film such as, for example, copper foil and aluminum foil. In addition, although not shown in the figure, this positive electrode current collector 18 may be formed on the surface of an insulating base material. A plate-like member formed from an insulating material may be used as the base material, and examples of the insulating material include, for example, resins, glass, and ceramics. In addition, the base material may be a flexible substrate with flexibility.

Further, this lithium ion secondary battery 1 may be appropriately provided with tab electrodes, not shown, and a plurality of lithium ion secondary batteries 1 may be connected in series and/or in parallel to provide a lithium ion secondary battery device.

This structured lithium ion secondary battery 1 according to the present preferred embodiment is thin and easily bent and folded. In addition, high efficiency and high output power can be achieved because of having the high-density negative electrode active material layer 12 and the high-density positive electrode active material layer 16. Therefore, the lithium ion secondary battery 1 according to the present preferred embodiment can be a small-size and high-performance battery.

(2) Method for Manufacturing Electrode and Lithium Ion Secondary Battery According to the Present Preferred Embodiment

Next, a method will be described for manufacturing the electrode and lithium ion secondary battery 1 according to the present preferred embodiment described above. For manufacturing the lithium ion secondary battery 1 according to the present preferred embodiment, in accordance with the method for manufacturing an electrode for a battery according to the present invention, the negative electrode active material layer 12 is formed on the negative electrode current collector 10 shown in FIG. 1, the solid electrolyte layer 14 is formed on the upper surface of the negative electrode active material layer 12 of the negative electrode, and the positive electrode active material layer 16 and the positive electrode current collector 18 (positive electrode) are then formed on the upper surface of the solid electrolyte layer 14.

(2-1) Negative Electrode

First, a method will be described for manufacturing the negative electrode according to the present preferred embodiment. The negative electrode according to the present preferred embodiment is manufactured by the method for manufacturing an electrode for a battery according to the present invention, which includes the following steps (i) to (iv):

(i) a mixing step of dry-mixing a negative electrode active material and a conductive aid;

(ii) a pressing step of applying a pressure for pressing to the mixture obtained in the mixing step;

(iii) a step of mixing a solvent into the mixture after the pressing step to prepare a slurry negative electrode active material; and

(iv) an application step of applying the slurry negative electrode active material onto a negative electrode current collector to form a negative electrode active material layer.

(i) Mixing Step

First, a negative electrode active material and a conductive aid are dry-mixed. In this case, the powdery negative electrode active material and the powdery conductive aid are mixed at a ratio by weight of 8:1, for example. The negative electrode active material and the conductive aid may be mixed with the use of, for example, a device for mixing a powder mixture by rotating a blade, or a planetary centrifugal mixer or the like.

(ii) Pressing Step

Then, a pressure is applied for pressing to the mixture obtained in the mixing step. The method for pressing may be any method as long as the method can apply a pressure to the mixture to improve the tap densities of the powdery negative electrode active material and powdery conductive aid considered bulky generally.

For example, examples of the method include a method of putting the mixture into a bag and applying a pressure to the bag with the use of plate press, roll press, or mold press.

In this pressing step, a pressure of 5 MPa (megapascal) or more and 300 MPa or less (5 MPa to 300 MPa) is preferably applied for pressing to the mixture as described above. Above all, a pressure of 30 MPa or more and 100 MPa or less (30 MPa to 100 MPa) is more preferably applied for pressing. The pressure of 5 MPa or more decreases the volumes of the powder mixture and active material obtained by using this mixture, and has advantages such as a decrease in the viscosity of the obtained slurry active material and an improvement in the filling ratio of the finally obtained electrode. The pressure of 300 MPa or less will not destroy the active material.

(iii) Preparation Step

The mixture hardened through the pressing step is, for example, taken out of the bag, crushed, and then mixed with a solvent, a binder, and other additives in the same way as in the mixing step (i) to prepare a slurry negative electrode active material. This preparation may be carried out by a conventionally known method.

The slurry negative electrode active material is composed of a mixture obtained by stirring and mixing (kneading) the negative electrode active material, the conductive aid, a binder, a solvent, and the like in a conventional manner, and able to have various degrees of viscosity so that the material can be discharged from a nozzle 40 described later. In the present preferred embodiment, the viscosity preferably has a lower limit on the order of 10 Pa·s and an upper limit on the order of 10000 Pa·s, for example, at a shear rate of 1 s⁻¹. It is to be noted that the respective constituents may be dissolved or dispersed in the solvent (including a case where some of the constituents are dissolved, whereas the rest is dispersed).

In addition, while the negative electrode active material for use in the application step can have various solid content ratios so that the negative electrode active material can be discharged from the nozzle 40 described later, the material preferably has a solid content ratio smaller than the solid content ratio at the sintering point of the mixture.

The viscosity and solid content ratio also vary depending on the types and combination amounts of the constituents such as the negative electrode active material, the conductive aid, the binder, and the solvent, the size or the shape, etc, and can be adjusted by the length of the kneading time in stirring and mixing (kneading) the negative electrode active material, the conductive aid, the binder, the solvent, etc. in a conventional manner.

As the binder, ones commonly used in the technical field of the present invention can be used, and examples of the binder include, for example, polyvinylidene fluoride (PVDF), polytetrafluoroethylene (PTFE), polyethylene, polypropylene, aramid resins, polyamide, polyimide, polyamideimide, polyacrylonitrile, polyacrylic acid, polyacrylic acid methyl esters, polyacrylic acid ethyl ester, polyacrylic acid hexyl ester, polymethacrylic acid, polymethacrylic acid methyl esters, polymethacrylic acid ethyl esters, polymethacrylic acid hexyl esters, polyvinyl acetate, polyvinylpyrrolidone, polyether, polyether sulfone, polyhexafluoropropylene, styrene-butadiene rubbers, ethylene-propylenediene copolymers, and carboxymethyl cellulose. In addition, copolymers of monomer compounds selected from tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, hexadiene, etc. can be used as the binder. One of the binders may be used singly, or two or more thereof may be used in combination, if necessary.

It is preferable to use an organic solvent as the solvent, excluding water, so as not to decompose lithium hexafluorophosphate (LiPF₆) or the like constituting the solid electrolyte layer 14. As the organic solvent, ones commonly used in the technical field of the present invention can be used, and example of the organic solvent include, for example, dimethylformamide, dimethylacetamide, methylformamide, N-methyl-2-pyrrolidone (NMP), dimethylamine, acetone, and cyclohexanone. One of the organic solvents may be used singly, or two or more thereof may be used in combination.

(iv) Application Step

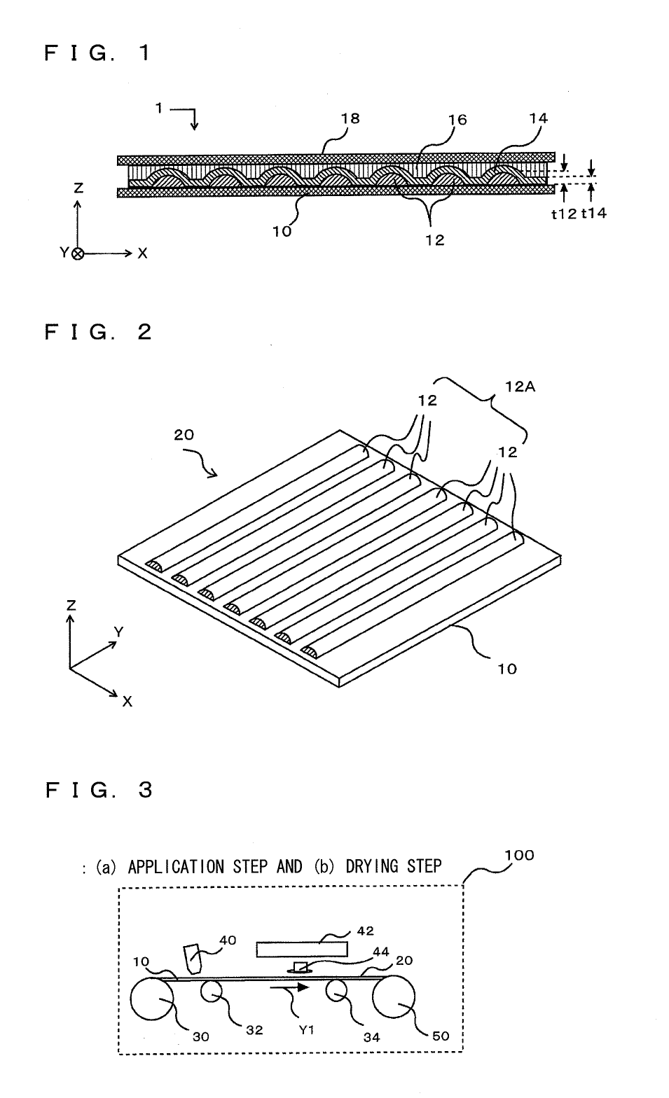

Next, the slurry negative electrode active material is applied onto the negative electrode current collector 10 to form the negative electrode active material layer 12. FIG. 3 shows respective sections for carrying out the application step (iv) and a drying step (v) described later, in a negative electrode manufacturing apparatus 100.

The application step section of the negative electrode manufacturing apparatus 100 according to the present preferred embodiment is configured such that the negative electrode current collector 10 fed from a wind-off roller 30 is first conveyed by a conveying roller 32 and a conveying roller 34 in the direction of an arrow Y1, and wound up by a wind-up roller 50. More specifically, the conveying roller 32 and conveying roller 34 can be regarded as scanning means for relatively moving the nozzle 40 relative to the negative electrode current collector 10. Thus, during the period between the feeding from the wind-off roller 30 and the wind-up by the wind-up roller 50, a negative electrode active material layer pattern 12A (see FIG. 2) composed of negative electrode active material layers 12 is formed on the surface of the negative electrode current collector 10 as shown in FIG. 3.

More specifically, the paste negative electrode active material is discharged into a linear shape from the nozzle 40 onto the surface of the conveyed negative electrode current collector 10. In the present preferred embodiment, the nozzle 40 is relatively moved relative to the negative electrode current collector 10 by conveying the negative electrode current collector 10 while fixing the nozzle 40. In this case, the negative electrode active material layer pattern 12A which forms linear shapes as shown in FIG. 2 is formed by discharging the negative electrode active material from the nozzle 40.

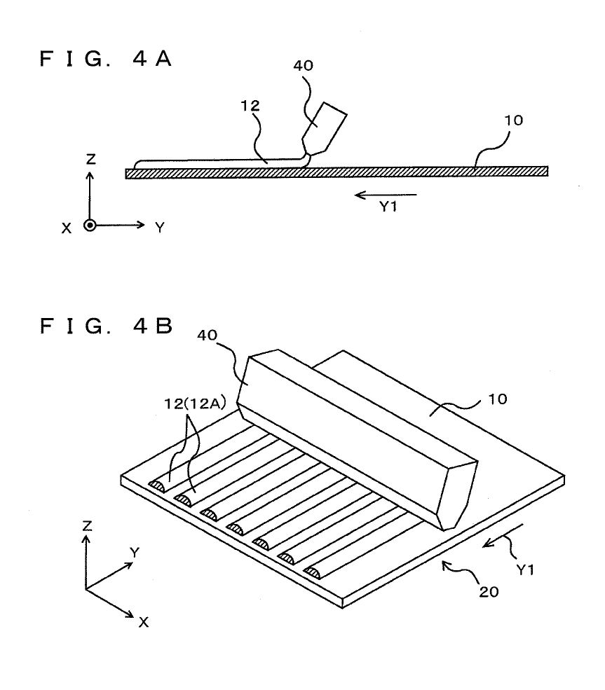

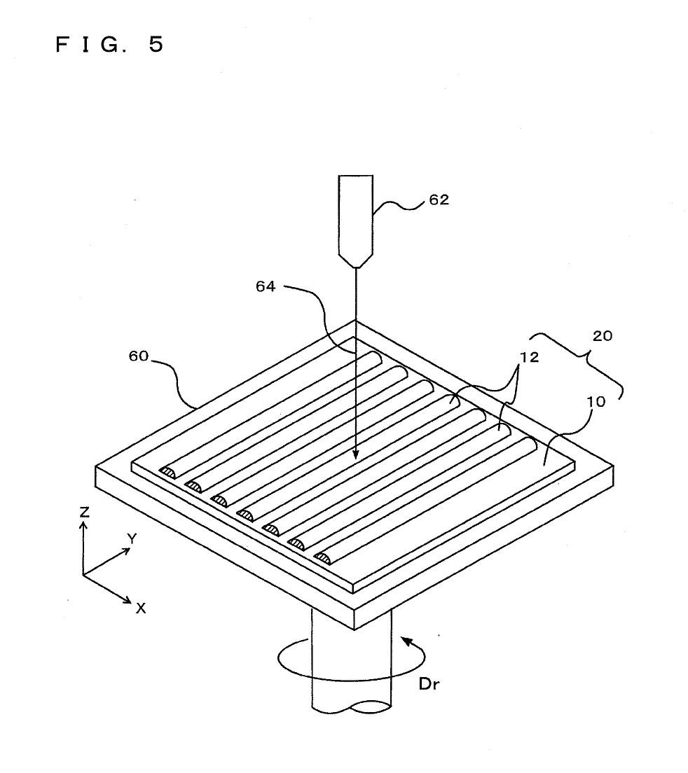

FIG. 4A is a side view schematically illustrating the formation of the negative electrode active material layer pattern 12A composed of the negative electrode active material layers 12 (that is, a diagram as viewed from a direction substantially parallel to the principal surface of the conveyed negative electrode current collector 10) in the negative electrode manufacturing apparatus 100 according to the present preferred embodiment as shown in FIG. 3, whereas FIG. 4B is a perspective view schematically illustrating the formation of the negative electrode active material layer pattern 12A composed of the negative electrode active material layers 12 therein.

In this nozzle dispensing method, the nozzle 40 provided with one or more discharge holes (not shown) for discharging the negative electrode active material as an application liquid is placed above the negative electrode current collector 10, and the negative electrode current collector 10 is relatively conveyed at a constant rate in the direction of the arrow Y1 relative to the nozzle 40 while discharging a certain amount of the negative electrode active material from the discharge holes.

Thus, the plurality of negative electrode active material layers 12 is applied and formed in a striped shape in the Y direction on the negative electrode current collector 10. It is to be noted that the discharge holes of the nozzle 40 are also substantially semicircular in shape because the negative electrode active material layers 12 are substantially semicircular in cross-sectional shape as shown in FIGS. 1 and 2 in the present preferred embodiment.

The nozzle 40 provided with the plurality of discharge holes can form the plurality of negative electrode active material layers 12 in a striped shape, and the negative electrode active material layers 12 can be formed in a striped shape over the entire surface of the negative electrode current collector 10 fed from the wind-off roller 30 by continuing to convey the negative electrode current collector 10. The negative electrode current collector 10 with the negative electrode active material layers 12 formed is wound up as a rolled negative electrode by the wind-up roller 50, after going through the drying step described later.

(v) Drying Step

Because the stripe-shaped negative electrode active material layer pattern 12A composed of the plurality of negative electrode active material layers 12 formed as described above has a state of a so-called applied film still containing the solvent, etc., the negative electrode current collector 10 with the negative electrode active material layer pattern 12A provided is conveyed so as to pass through a lower region of drying means 42. In this lower region, the negative electrode active material layer pattern 12A composed of the plurality of negative electrode active material layers 12 is subjected to a drying step with dry air 44. It is to be noted that complete drying is not always necessary.

The drying temperature for the drying step may be any temperature to the extent that the advantageous effect of the present invention is not undermined, and may be a temperature within the range of, for example, 5° C. to 150° C. In addition, the drying time for the drying step can be also controlled by the speed of conveying the negative electrode current collector 10, and may be approximately 10 minutes to 24 hours while the drying time also varies depending on the composition and solid content ratio of the negative electrode active material layer. It is to be noted that the drying means 42 may be any conventionally known means, and for example, an air blower, or a drying furnace or the like using hot air, far-infrared rays, or vacuum drying, etc. can be used.

At this point, the negative electrode active material layers 12 are formed which are raised relative to the surface of the substantially flat negative electrode current collector 10, while the dense and high-density negative electrode active material layers 12 are formed because the slurry negative electrode active material is prepared through the mixing step and the pressing step as described previously.

(2-2) Solid Electrolyte Layer

While the method for forming the solid electrolyte layer 14 on the upper surface of the negative electrode 20 composed of the negative electrode current collector 10 and the negative electrode active material layers 12 as described above is not to be considered particularly limited because conventionally known methods can be employed, a solid electrolyte material is applied by, for example, a spin coating method to form the solid electrolyte layer 14 in the present preferred embodiment.

FIG. 5 is a diagram schematically illustrating the application of a solid electrolyte material by a spin coating method in the present preferred embodiment. As shown in FIG. 5, the negative electrode 20 of the negative electrode current collector 10 and negative electrode active material layers 12 stacked is placed substantially horizontally on a rotation stage 60 that is rotatable around a vertical (z-direction) rotation axis in a predetermined rotational direction Dr.

Therefore, in the present preferred embodiment, the negative electrode composed of the negative electrode current collector 10 with the negative electrode active material layers 12 formed is cut in a direction substantially perpendicular to the length direction of the negative electrode current collector 10 into a size that can be placed on the rotation stage 60, and the solid electrolyte layer 14 is then formed.

While rotating the rotation stage 60 at a predetermined rotation speed, a paste solid electrolyte material 64 as an application liquid is discharged toward the negative electrode 20 from a nozzle 62 provided in an upper position on the rotation axis of the rotation stage 60. The solid electrolyte material dropped on the upper surface of the negative electrode 20 is gradually spread peripherally by centrifugal force of the rotating rotation stage 60, and the extra solid electrolyte material is blown off from ends of the negative electrode 20.

Through this mechanism, the upper surface of the negative electrode 20 is covered uniformly with the thin solid electrolyte material, and this material can be hardened by drying to form the solid electrolyte layer 14. The composition, viscosity, and solid solution ratio of the solid electrolyte material used, as well as the conditions for hardening by drying may be appropriately selected in accordance with conventionally known methods, to the extent that the advantageous effect of the present invention is not undermined.

In the spin coating method, the film thickness of the solid electrolyte layer 14 obtained can be controlled by the viscosity of the solid electrolyte material and the rotation speed of the rotation stage 60, and even onto an object to be coated with surface asperity as in the case of the negative electrode 20 in the present preferred embodiment, the thin-film solid electrolyte layer 14 which is uniform in film thickness can be formed to follow the asperity.

While the solid electrolyte layer 14 may have any thickness, it is necessary for the thickness to ensure that the negative electrode active material layer 12 and the positive electrode active material layer 16 are separated from each other, and to keep the internal resistance from being excessively increased. It is to be noted that in order not to undermine the effect of the surface area increased by providing the negative electrode active material layer 12 with asperity, the thickness t14 (reference numeral t14 in FIG. 1) of the solid electrolyte layer 14 and the difference t12 (reference numeral t12 in FIG. 1) in asperity height of the negative electrode active material layer 12 desirably satisfy the relational expression: t14<t12.

(2-3) Positive Electrode

While the method for forming the positive electrode active material layer 16 on the upper surface of a stack body 70 obtained by stacking the negative electrode current collector 10, negative electrode active material layer 12, and solid electrolyte layer 14 formed as described above is not to be considered particularly limited because conventionally known methods can be employed, a paste positive electrode active material is applied by, for example, a doctor blade method to form the positive electrode active material layer 16 in the present preferred embodiment.

While materials obtained by stirring and mixing (kneading) the positive electrode active material, conductive aid, binder, and solvent mentioned above, etc. can be used as the positive electrode active material, the composition, viscosity, and solid content ratio of the positive electrode active material used, as well as the conditions for hardening by drying may be appropriately selected in accordance with conventionally known methods to the extent that the advantageous effect of the present invention is not undermined.

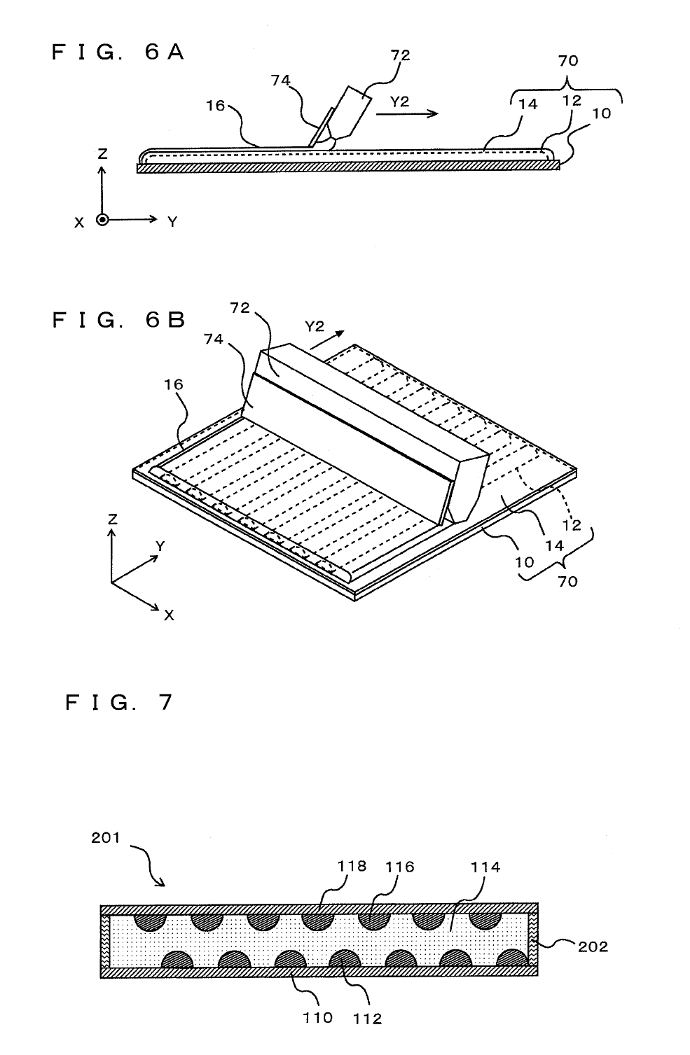

FIGS. 6A and 6B are diagrams schematically illustrating the application of a positive electrode active material by a doctor blade method. More specifically, FIG. 6A is a side view schematically illustrating the formation of the positive electrode active material layer 16 through the application of a positive electrode active material onto the upper surface of the stacked body 70 by a doctor blade method (that is, a diagram as viewed from a direction substantially parallel to the principal surface of the negative electrode current collector 10 with the negative electrode active material layers 12), whereas FIG. 6B is a perspective view schematically illustrating the formation of the positive electrode active material layer 16 through the application of the positive electrode material.

A nozzle 72 for discharging the positive electrode active material is scan-moved relatively in a direction indicated by an arrow Y2 relative to the stacked body 70. In the movement direction Y2 of the nozzle 72, a doctor blade 74 is attached to the back of the nozzle 70, and the lower end of the doctor blade 74 is brought into the upper surface of the discharged positive electrode active material in an upper position from the solid electrolyte layer 14 formed on the upper surface of the stacked body 70. Thus, the positive electrode active material layer 16 can be obtained which has a flat upper surface.

The nozzle 72 for use in this step may be a nozzle with a number of discharge holes as in the case of the nozzle 40 shown in FIGS. 4A and 4B, or a nozzle with slit-like discharge holes extending in a direction (that is, the direction of an arrow X) orthogonal to the movement direction Y2.

In this way, the positive electrode active material layer 16 which has a lower surface with asperity to follow the asperity of the solid electrolyte layer 14 and a substantially flat upper surface can be formed on the upper surface of the stacked body 70 by applying the positive electrode active material onto the stacked body 70.

The lithium ion secondary battery 1 according to the present preferred embodiment, which has the structure shown in FIG. 1, can be obtained by stacking the positive electrode current collector 18 on the upper surface of the positive electrode active material layer 16 formed in the way described above. As the positive electrode current collector 18, conventionally known materials can be used, and metal foil can be used such as, for example, copper foil.

In this case, the positive electrode current collector 18 is preferably stacked before the positive electrode active material layer 16 is hardened, because the positive electrode active material layer 16 and the positive electrode current collector 18 can be closely joined with each other. In addition, the positive electrode current collector 18 can be stacked without gaps, because the upper surface of the positive electrode active material layer 16 is substantially flat.

<<Modification Aspect>>

While an example of preferred embodiments of the present invention has been described above, the present invention is not to be considered limited to only these preferred embodiments, and various modifications can be made besides the above description, without departing from the spirit of the present invention. For example, while a case of forming the negative electrode including the negative electrode current collector 10 and the negative electrode active material layer 12 by the method for manufacturing an electrode for a battery according to the present invention has been described above in the preferred embodiment, the positive electrode including the positive electrode current collector 18 and the positive electrode active material layer 16 may be formed by the method for manufacturing an electrode for a battery according to the present invention.

In the case of forming the positive electrode including the positive electrode current collector and the positive electrode active material layer in accordance with the method for manufacturing an electrode for a battery according to the present invention, the same conditions, etc, as in the case of the negative electrode active material layer may be adopted.

In addition, while a case of the linear negative electrode active material layer 12 has been described above in the preferred embodiment, the negative electrode active material layer may be a flat film. The positive electrode active material layer 16 may be a flat film.

Furthermore, while a case of forming the negative electrode including the negative electrode current collector 10 and the negative electrode active material layer 12 by the method for manufacturing an electrode for a battery according to the present invention has been described above in the preferred embodiment, the negative electrode including the negative electrode current collector 10 and the negative electrode active material layer 12 and the positive electrode including the positive electrode current collector 18 and the positive electrode active material layer 16 may be both formed by the method for manufacturing an electrode for a battery according to the present invention. Furthermore, while a case of carrying out the drying step after the application step by the drying means in the manufacture of the negative electrode has been described above in the preferred embodiment, natural drying may be adopted without using the drying means, or vacuum drying may be carried out.

It is to be noted that while the pattern of the negative electrode active material layers 12 drawn onto the negative electrode current collector 10 has a so-called line-and-space structure composed of a plurality of stripes arranged at regular intervals in the preferred embodiment, the drawn pattern is not to be considered limited to this structure. In addition, while a case of the substantially semicircular cross-sectional shape immediately after the application of the negative electrode active material layers 12 has been described above in the preferred embodiment, the cross-sectional shape is not to be considered limited to this case, and may be a substantially rectangular shape such as a square, a rectangular, or a trapezoidal shape.

Various patterns can be formed in a short period of time, because the application achieved by a nozzle dispensing method is applied to the formation of the negative electrode active material layers 12 which require the formation of an asperity pattern. In addition, it is also possible to preferably apply the nozzle dispensing method to the creation of microscopic patterns. In this manufacturing method, it is only the initial application step, that is, the step of applying the active material application liquid that requires the creation of a microscopic pattern, and the subsequent application steps only have to carry out uniform applications, and require no microscopic pattern preparation.

It is to be noted that the present invention is not to be considered limited to the preferred embodiments described above, various modifications can be made besides the above description, without departing from the spirit of the present invention. For example, the application methods applied in the respective steps are not to be considered limited to the methods mentioned above, and other application methods may be applied as long as the methods fit for the purposes of the steps. For example, while the spin coating method is applied to the formation of the solid electrolyte layer 14 in the preferred embodiment described above, the solid electrolyte material may be applied by, for example, a spray coating method as long as the method can form a thin film to follow asperity of a surface to be subjected to the application.

In addition, for example, while the doctor blade method is applied to the formation of the positive electrode active material layer 16 in the preferred embodiment described above, other application methods may be adopted as long as the methods are able to cause the lower surface in contact with a surface to be subjected to the application to follow asperity of the surface, and give the upper surface substantially flat finish. While the viscosity of the positive electrode active material is preferably not so high in order to achieve these purposes, it is possible, in other words, to give the lower surface asperity and give the upper surface substantially flat finish without using any doctor blade as long as the viscosity of the positive electrode active material is appropriately selected, and the material may be applied by, for example, a nozzle dispensing method, a slit coating method, a bar-coating method, or the like.

In addition, while a case of preparing an all-solid lithium ion secondary battery that has the structure shown in FIG. 1 has been described above in the preferred embodiment, the present invention is not limited to this case, and can be also applied in the case of preparing lithium ion secondary batteries that have various structures as long as the batteries have active material layers (an active material pattern) of a line-and-space structure.

For example, the present invention can be also applied as a method for manufacturing a lithium ion secondary battery that has a structure shown in FIG. 7. FIG. 7 is a schematic longitudinal sectional view of a lithium ion secondary battery manufactured according to a modification aspect of the present invention. In the case of a lithium ion secondary battery 201 shown in FIG. 7, a negative electrode is configured with a negative electrode active material layer 112 provided on one surface (an upper surface in FIG. 7) of a negative electrode current collector 110 by the method for manufacturing an electrode for a battery according to the present invention. In addition, a positive electrode is configured with a positive electrode active material layer 116 provided on one surface (a lower surface in FIG. 7) of a positive electrode current collector 118 by the method for manufacturing an electrode for a battery according to the present invention.

Further, the negative electrode (the negative electrode active material layer 112 and the negative electrode current collector 110) and the positive electrode (the positive electrode active material layer 116 and the positive electrode current collector 118) are placed to be opposed with a spacer 202 of, for example, an insulating material interposed therebetween, and put in a battery can, an electrolyte liquid 114 is then injected into the internal space formed by the negative electrode current collector 110, the spacer 202, and the positive electrode current collector 118, and the battery can is hermetically sealed or the like, thereby constituting the lithium ion secondary battery 201. It is to be noted that a separator may be interposed in the internal space.

### Example 1

A powder mixture obtained by uniformly dry-mixing lithium titanate (LTO) and acetylene black (AB) at a ratio by weight of 8:1 was put into a bag made of polyethylene (PE). This bag was subjected to pressing under the condition of 30 MPa for 6 minutes with the use of a hand press. At this point, the powder mixture was hardened.

Next, the hardened powder mixture was taken out of the bag, crushed, and then mixed with polyvinylidene fluoride (PVdF) so as to achieve a ratio by weight of LTO:AB:PVdF=8:8:1, and then, so as to achieve a desired viscosity (50 Pa·s to 100 Pa·s), stirred and mixed for 30 minutes with a planetary centrifugal mixer with the addition (40 weight %) of N-methyl-2-pyrrolidone (NMP) to prepare a slurry active material.

Then, the slurry active material was applied onto a current collector (aluminum foil), and dried under the conditions of 80° C. and 120 minutes to form an active material layer. In this way, the present invention was used to prepare an electrode 1 including the active material layer and the current collector.

### Comparative Example 1

A comparative electrode 1 including an active material layer and a current collector was prepared in the same way as in Example 1, except that the pressing with the powder mixture put into the bag was not carried out.

[Evaluation]

It was examined how the porosity and thickness of the active material layer were changed between before and after the electrode 1 and comparative electrode 1 prepared in the way described above were subjected to pressing (30 MPa and 3 minutes) as a subsequent step. The viscosity was measured with the use of a revolving type viscometer. In addition, the porosity was obtained by a method of computing the true volume from the weight and the true density, and calculating with the ratio of the volume to the actual film thickness. As for the thickness, the average of values obtained by measuring at five points with a dial gauge was regarded as the thickness. The results are shown in Table 1.

TABLE 1

| | Comparative | |
|---|---|---|
| | Example 1 | Example 1 |
| | Without Pressing for | With Pressing for |
| | Powder Mixture | Powder Mixture |
| Viscosity (Pa · S) | 76 | 55 |
| Compressibility (rate | 14.3% | 5% |
| of thickness change | | |
| between before and after | | |
| pressing) | | |
| Porosity/Thickness (μm) | 43%/70 | 32%/58 |
| before Pressing | | |
| Porosity/Thickness (μm) | 29%/56 | 28%/55 |
| after Pressing | | |

From the results shown in Table 1, it is determined that the porosity and thickness are nearly unchanged respectively from 32% and 58 μm to 28% and 55 μm between before and after the pressing as a subsequent step in the case with pressing for the powder mixture, and the pressing as a subsequent step can be thus skipped.

### Example 2

A powder mixture obtained by uniformly dry-mixing lithium titanate (LTO) and acetylene black (AB) at a ratio by weight of 8:1 was put into a bag made of polyethylene (PE). This bag was subjected to pressing under the condition of 30 MPa for 6 minutes with the use of a hand press. At this point, the powder mixture was hardened.

Next, the hardened powder mixture was taken out of the bag, crushed, and then mixed with polyvinylidene fluoride (PVdF) so as to achieve a ratio by weight of LTO:AB:PVdF=8:8:1, and then, so as to achieve a desired viscosity (on the order of 4000 Pa·s), stirred and mixed for 6 minutes with a planetary centrifugal mixer with the addition of N-methyl-2-pyrrolidone (NMP) to prepare a slurry active material.

Then, the slurry active material was applied onto a current collector (aluminum foil) so as to provide a structure as shown in FIG. 2, and dried under the conditions of 80° C. and 120 minutes to form linear active material layers. The dimensions of the linear active material layers were adjusted to 70 μm in width and 150 μm in height, and the space between the linear active material layers was adjusted to 80 μm. In this way, the present invention was used to prepare an electrode 2 including the active material layer and the current collector.

### Comparative Example 2

A comparative electrode 2 including an active material layer and a current collector was prepared in the same way as in Example 2, except that the pressing with the powder mixture put into the bag was not carried out.

[Evaluation]

The electrode 2 and comparative example 2 prepared in the way described above were examined for capacity (mAh/cm²) and porosity. The capacity was obtained by a method of weighing the punched electrode and calculating the weight of only the active material. In addition, the porosity was obtained with the use of the following formula (I) by computing the true volume from the weight and the true density, and calculating with the ratio of the true volume to the actual volume. The solid content was obtained from the ratio between the powder weight and the solvent weight in the slurry preparation. The results are shown in Table 2.

$$\begin{matrix}[ Formula 1 ] & \\ Porosity ( \% ) = \frac{[ \begin{matrix}Actual Volume ( {cm}^{3} ) - \\ \frac{Active Material Weight ( mg )}{True Density ( mg \text{/} {cm}^{3} )}\end{matrix} ]}{Actual Volume ( {cm}^{3} )} \times 100 & Formula ( 1 )\end{matrix}$$

TABLE 2

| | Comparative | |
|---|---|---|
| | Example 2 | Example 2 |
| | Without Pressing for | With Pressing for |
| | Powder Mixture | Powder Mixture |
| Viscosity (Pa · S) | approximately 4000 | approximately 4000 |
| Solid Content | 55 weight % | 58 weight % |
| Capacity (mAh/cm²) | 1 | 1.25 |
| Porosity of Electrode | 47% | 36% |

From the results shown in Table 2, it is determined that the excellent capacity and porosity are achieved without carrying out pressing as a subsequent step in the case with pressing for the powder mixture, and the pressing as a subsequent step can be skipped. It is to be noted that when the pressing as a subsequent step was carried out, the plurality of linear active material layers was crushed and deformed into flat layers of 60 μm in thickness, depending on the space. The narrower space results in the layers in contact with each other, whereas the wider space results in a line-and-space structure with a low aspect ratio.

While the invention has been shown and described in detail, the foregoing description is in all aspects illustrative and not restrictive. It is therefore understood that numerous modifications and variations can be devised without departing from the scope of the invention.

What is claimed is:

1. A method for manufacturing an electrode for a battery, the method comprising the steps of:
a) dry-mixing an active material and a conductive aid;
b) applying a pressure for pressing to the mixture obtained in said step a);
c) mixing a solvent into said mixture after said step b) to prepare a slurry active material; and
d) applying said slurry active material onto a current collector to form an active material layer.

2. The method for manufacturing an electrode for a battery according to claim 1,
wherein a pressure of 5 MPa or more and 300 MPa or less is applied to said mixture for pressing in said step b).
